(19) United States
(12) Patent Application Publication
(10) Pub. No.: US 2009/0216593 A1
(43) Pub. Date: Aug. 27, 2009

(54) POINT SOURCE ASSET SYSTEM AND METHOD THEREOF

(76) Inventors: Ron Gonen, New York, NY (US); Frank Yang, Framingham, MA (US); David Yang, New York, NY (US)

Correspondence Address: MALDJIAN & FALLON LLC, 365 BROAD ST. , 3RD FLOOR, RED BANK, NJ, 07701, US

(21) Appl. No.: 12/435,587

(22) Filed: May 5, 2009

Related U.S. Application Data
(63) Continuation-in-part of application No. 11/345,867, filed on Feb. 2, 2006.
Application No. 11/345,867 is a continuation-in-part of application No. 11/854,387, filed on Sep. 12, 2007.
(60) Provisional application No. 60/650,610, filed on Feb. 7, 2005.
(60) Provisional application No. 61/050,470, filed on May 5, 2008.

(51) Int. Cl. G06Q 10/00; G06Q 30/00; G06Q 50/00

(52) U.S. Cl. 705/7; 705/14

(57) ABSTRACT

Embodiments of the present invention relate to a point-source asset system for managing an incentive-based environmentally-conscious behavior program and methods of implementing the same. In one embodiment, a system comprises: an administrative entity, communicably accessible via a computer network, comprising a database; a consumer entity having an entity account stored on the database; an environmentally-conscious sub-program, comprising a point-source asset, associated with the consumer entity; a means for monitoring point-source asset activity within the environmentally-conscious sub-program; and a means for granting a credit value, correlating to the point-source asset activity, to the entity account.

### CROSS-REFERENCE TO RELATED APPLICATIONS

This application is a continuation-in-part of U.S. patent application Ser. No. 11/345,867, filed Feb. 2, 2006, which claims the benefit of U.S. Provisional Patent Application Ser. No. 60/650,610, filed Feb. 7, 2005, the disclosures of which are incorporated herein by reference in their entireties. This application is also a continuation-in-part of U.S. patent application Ser. No. 11/854,387, filed Sep. 12, 2007, the disclosure of which is incorporated herein by reference in its entirety. This application also claims the benefit of U.S. Provisional Patent Application Ser. No. 61/050,470, filed May 5, 2008, the disclosure of which is incorporated herein by reference in its entirety.

### BACKGROUND

1. Field of the Invention

Embodiments of the present invention generally relate to a point source asset system and method thereof. More specifically, embodiments of the present invention relate to a point source asset system for managing an incentive-based environmentally-conscious behavior program and methods of implementing and utilizing the same.

2. Description of the Related Art

Over the past few decades, costs for collecting and disposing waste material (“waste”) have skyrocketed. Decreases in available landfill capacity have caused the cost associated with disposing of waste in such landfills to increase. Adding to these costs are governmental (e.g., federal, state and local) landfill taxes, which have also increased sharply over the past few decades.

Even where landfill capacity exists, the cost associated with potential and actual environmental hazards associated with landfill operation are likewise increasing. These costs can include, for example, losses of valuable property and environmental cleanup costs for rehabilitating landfills and surrounding areas that become contaminated with dangerous chemicals due to the disposal and decomposition of the waste. Given the financial and environmental burdens associated with the collection and disposal of waste, municipalities have actively pursued recycling as an alternative to disposal.

Fortunately, demand for recyclable material has increased as a result of expansion in manufacturing. Manufacturers have long recognized that manufacturing goods from recyclable material is less costly than manufacturing such goods from virgin material due to, for example, the costs associated with extracting and processing the virgin material into useable form.

Advances in Single Stream Recycling (SSR) technology reduce the cost of recycling. In addition, recent improvements in automated separation of comingled recyclable material at processing centers have dramatically reduced the cost of collecting, sorting, and processing the recyclable material. The combination of the SSR technology and automated separation enables an automated process to separate and process comingled recyclable material (for example, cardboard, paper, plastic, glass and aluminum material). This combination enables and permits processing centers to cut costs (e.g., reduce labor costs and sorting time) by using an automated process, as opposed to manual labor, to separate the recyclables. In addition, the combination enables municipalities to cut cost of collection by collecting the recyclable material in comingled form.

While information-technology tools have revolutionized the way many governments and industries operate, the waste management industry has not embraced information technology in the same way. As such, the waste management industry lacks modern, up-to-date information technology tools for efficiently carrying out business management, operations management and other activities associated with recycling and waste reduction. In turn, the lack of information-technology tools has limited municipalities and/or other entities administering recycling and waste management programs to provide incentives for entities, such as business, governments and households, to recycle and reduce waste, to design effective strategies therefor, to measure performance against such strategies, and the like.

Recycling reduces the financial and environmental burdens of waste disposal, reduces energy costs, and conserves our environments resources. Therefore, there is a need to establish recycling initiatives that recognize the existing problems associated with the disposal of waste and promote recycling efforts as part of a waste management program.

### SUMMARY

Embodiments of the present invention relate to a point-source asset system for managing an incentive-based environmentally-conscious behavior program and methods of implementing the same. In one embodiment, a system comprises: an administrative entity, communicably accessible via a computer network, comprising a database; a consumer entity having an entity account stored on the database; an environmentally-conscious sub-program, comprising a point-source asset, associated with the entity account; a means for monitoring point-source asset activity within the environmentally-conscious sub-program; and a means for granting a credit value, correlating to the point-source asset activity, to the entity account.

In another embodiment of the present invention, a method of managing a system, comprises: providing a database hosted on a server at an administrative entity; creating an entity account within the database for a consumer entity; associating an environmentally-conscious sub-program, comprising a point-source asset, with the entity account; monitoring point-source asset activity within the environmentally-conscious sub-program; and granting a credit value, correlating to the point-source asset activity, to the entity account.

In yet another embodiment, there is provided a tangible computer-readable medium comprising program instructions, wherein the program instructions are computer-executable to implement: creating an entity account within the database for a consumer entity; associating an environmentally-conscious sub-program, comprising a point-source asset, with the entity account; monitoring point-source asset activity within the environmentally-conscious sub-program; and granting a credit value, correlating to the point-source asset activity, to the entity account.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments.

FIG. 1 depicts a general system in accordance with one embodiment of the present invention;

FIG. 2 depicts a block diagram of a general purpose computing system in accordance with one embodiment of the present invention;

FIG. 3 depicts a general flow chart of an exemplary method utilizing a curbside recycling and waste program in accordance with one embodiment of the present invention;

FIG. 4 depicts an exemplary kiosk apparatus in accordance with one embodiment of the present invention;

FIG. 5 depicts a general flow chart of an exemplary method utilizing a kiosk-based recycling and waste program in accordance with one embodiment of the present invention;

FIG. 6 depicts a general flow chart of an exemplary method utilizing a drop-off center recycling and waste program in accordance with one embodiment of the present invention;

FIG. 7 depicts a general flow chart of merely one exemplary method utilizing a commerce-based environmentally conscious program in accordance with one embodiment of the present invention;

FIG. 8 depicts a general flow chart of merely one exemplary method utilizing a utility- and commodity-based conservation program in accordance with one embodiment of the present invention;

FIG. 9 depicts a graphical representation of a point-source asset system in accordance with one embodiment of the present invention; and

FIG. 10 depicts a flowchart of a method of managing an incentive-based environmentally-conscious behavior program, in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention generally relate to a point source asset system and method thereof. More specifically, embodiments of the present invention relate to a point source asset system of organization for managing an incentive-based environmentally-conscious behavior program and methods of implementing and utilizing the same.

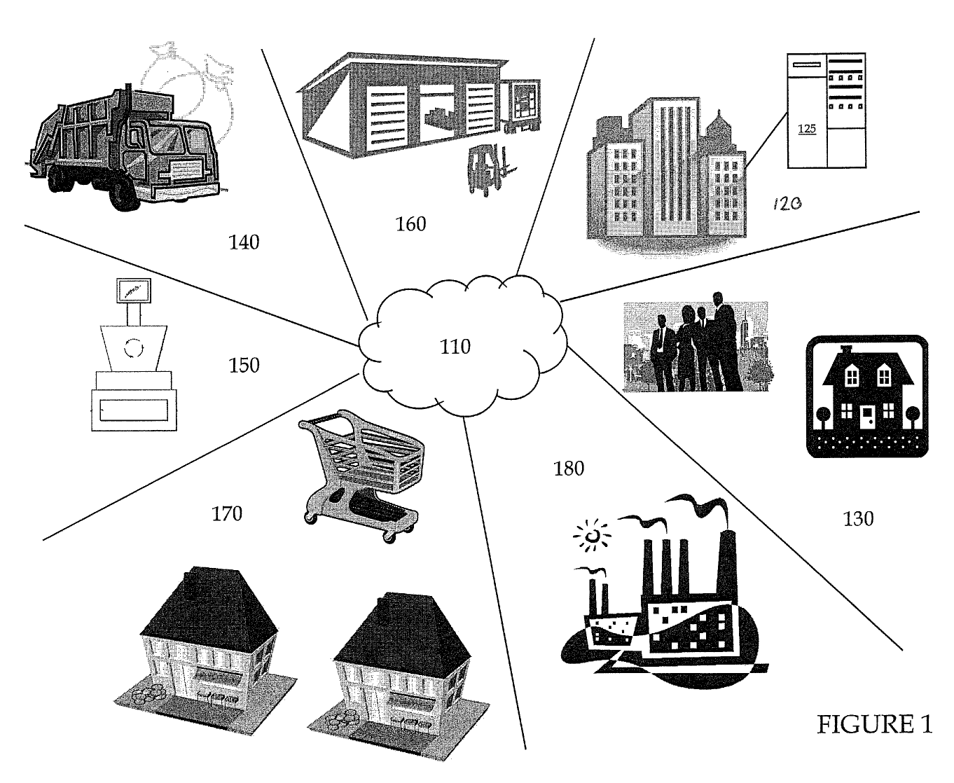

FIG. 1 depicts a general system in accordance with one embodiment of the present invention. The system 100 generally represents a world of environmentally-conscious persons, businesses, industries and/or other entities collectively working towards a smaller environmental footprint through the reduction, reuse and recycling of materials, goods, services and waste generated therefrom.

In an exemplary embodiment, the system 100 comprises an administrator 120 and at least a user 130 in communication via a network 110. Generally, the system 100 also comprises one or more environmentally-conscious sub-systems or programs. For example, the system 100 may comprise any one or more of curbside recycling and waste programs 140, kiosk-based recycling and waste programs 150, drop-off center recycling and waste programs 160, commerce-based environmentally-conscious systems and programs 170, utility- and commodity-based conservation programs 180, or the like.

The network 110 may comprise any network suitable for embodiments of the present invention. For example, the network 110 may be a partial or full deployment of most any communication/computer network or link, including any of, any multiple of, any combination of or any combination of multiples of a public or private, terrestrial wireless or satellite, and wireline networks or links. The network 110 may include, for example, network elements from a Public Switch Telephone Network (PSTN), the Internet, core and proprietary public networks, wireless voice and packet-data networks, such as 1G, 2G, 2.5G and 3G telecommunication networks, wireless office telephone systems (WOTS) and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

As contemplated by various embodiments of the present invention, the administrator 120 may comprise any organization or entity administering, monitoring, and/or regulating transactions between the multiple entities, users and/or programs and sub-systems within the system 100. In many embodiments, the administrator 120 is an administrative entity comprising a database 125 hosted on an accessible server, or other data management system suitable for embodiments of the present invention. In one embodiment, the administrator 120 is an incentive-based environmental loyalty program administrator, similar to the administrator disclosed in detail in U.S. patent application Ser. No. 11/854,387, published on Mar. 6, 2008 as United States Patent Application Publication No. 2008/0059970, the disclosure of which is incorporated herein by reference in its entirety.

In many embodiments, the database 125 may include a number of records into which entity data, recycling or waste data, resource data and/or other related information and data as discussed herein (collectively “information”), may be parsed, analyzed, managed and stored. The database software (not shown) may include and/or employ one or more database management systems (“DBMS”), such as any of an Oracle, DB2, Microsoft Access, Microsoft SQL Server, Postgres, MySQL, 4th Dimension, FileMaker and Alpha Five DBMS, and the like. The DBMS is operable to query the database 125, parse the information into records, execute rules for sorting the information parsed into the records, execute rules for performing operations (e.g., mathematical, statistical, logical, etc., operations) on the information parsed into the records, generate reports as a function of the information and rules, and the like. In addition, database 125, and its associated software, may include, define or otherwise form one or more models for determining an allocation of resources associated with carrying out embodiments of the present invention.

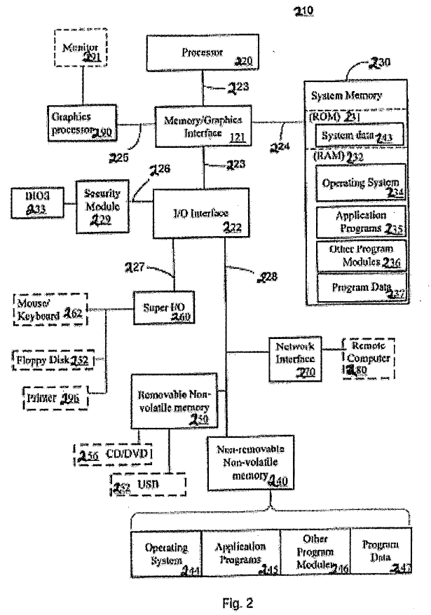

The user 130 may comprise any number of entities suitable for embodiments of the present invention, with as few as one, or as many as may be supported by the system 100 and methods disclosed herein. The term “user” and “entity” are interchangeably used herein. The user 130 may comprise or be representative of any individual, group, organization, business, corporation, or the like. In many embodiments, the user 130 may further comprise an electronic device for communication through the network 110 to the administrator 120. In several embodiments, the electronic device comprises a general purpose computer system, for example, the general purpose computer system of FIG. 2.

With reference to FIG. 2, a general purpose computing system in the form of a computer 210 is shown. As understood by embodiments of the present invention, components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and can accessed by the computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other buses 226, 227 and 228 that couple a variety of internal and external devices to the computer 210. A serial peripheral interface (SPI) bus 226 may connect to a BIOS memory 233 containing the basic routines that help to transfer information between elements within computer 210, such as during start-up.

In some embodiments, a security module 229 may be incorporated to manage metering, billing, and enforcement of policies.

A super input/output chip 260 may be used to connect to a number of ‘legacy’ peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 252 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media, discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different elements within the computer 210. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), an Ethernet-based network, a wide area network (WAN), or both, but may also include other networks. Such networking environments are commonplace in offices, enterprise-wide computer networks, intranets, and the Internet.

Returning to FIG. 1, often the system 100 comprises one or more environmentally-conscious sub-systems or programs suitable for embodiments of the present invention. Many of these types of sub-systems and programs are commercially available, and all have been developed, either commercially or conceptually, by RecycleBank LLC, with offices in New York, N.Y. The following are basic descriptions of many of these sub-systems and programs. It should be appreciated, however, embodiments of the present invention should not be limited to these sub-systems and programs disclosed herein, and should include any such environmentally-conscious sub-system or program, as understood by those of ordinary skill in the art.

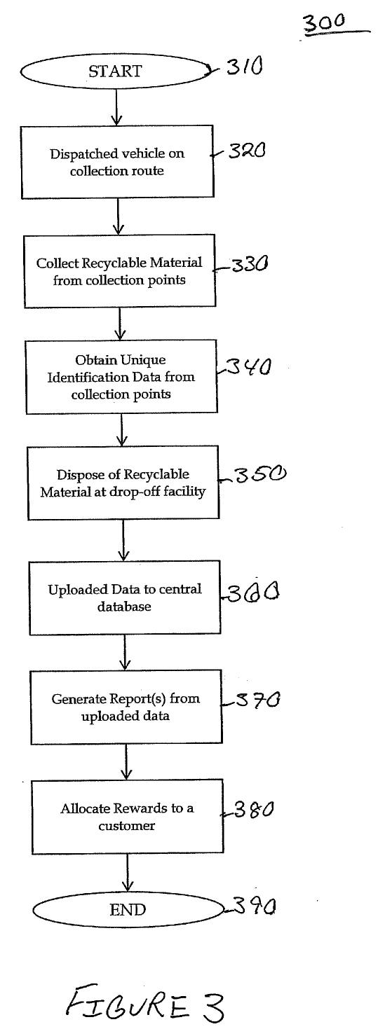

An exemplary curbside recycling and waste program 140 has been developed, and is commercially available through RecycleBank LLC and its affiliates. FIG. 3 depicts a general flow chart of an exemplary method utilizing a curbside recycling and waste program 140 in accordance with one embodiment of the present invention.

The method 300 begins at step 310. In one embodiment, at step 320, a vehicle, adapted for collection of recyclable materials, is dispatched on a predetermined, planned route. One exemplary type of vehicle is a “garbage truck,” such as the type disclosed by U.S. Pat. No. 4,242,311, which is incorporated herein by reference in its entirety.

At step 330, along the route, the vehicle stops at a series of collection points to collect recyclable or waste material. The collection points may comprise single family residences, places of business, apartment complexes, or the like. At each collection point, the vehicle collects a quantitative or qualitative measure of recyclable or waste material. Generally, such materials are contained within a bin or other storage container when collected. In many embodiments, the qualitative or quantitative measurement of materials takes into consideration the weight or volume of the storage container. One exemplary storage container is disclosed by United States Patent Application Publication No. 2006/0273180, the disclosure of which is incorporated herein by reference in its entirety.

At step 340, as the materials are being collected at each collection point at step 330, a set of unique identification data from the collection point is obtained. In accordance with one embodiment of the present invention, obtaining unique data from a collection point comprises obtaining information from an identification tag (e.g., a RFID tag, bar-code, magnetic-strip, etc.) on a container and measuring a quantitative (e.g., weight, mass, density, volume, etc.) or qualitative (percentage volume of the container filled, mere presence of recyclable or waste materials in the container, etc.) characteristic of the materials.

Once the unique data has been obtained from each of the collection points, and/or once the vehicle becomes full of materials, the vehicle enters a drop-off facility, where it can unload the recyclable material for further processing, at step 350. A drop-off facility may comprise a processing or treatment recycling plant, a landfill, a general waste management facility, a place of business in the trade of handling recyclable or waste materials, or the like.

At step 360, the unique data is uploaded to a central computer system. The central computer system may be any computer suitable for embodiments for the present invention, for example the general computer system of FIG. 2, and may also comprise a database (e.g., database 125 at the administrator 120) for storing such unique data.

At the database 125, uploaded unique data may be analyzed and organized according to any number of analytical methods. Optionally, at step 370, at least one report representative of the uploaded data is generated. The report may present the unique data and/or analysis of such data in any format or presentation medium suitable for embodiments of the present invention.

At step 380, a set of credit values are generated and allocated to a user, customer or client associated with a set of unique data. As this step 380 is quite common among all environmentally-conscious systems and programs within the scope of embodiments of the present invention, a further discussion of the allocation of rewards to a customer or client is provided below. The method 300 ends at step 390. A more detailed discussion of an exemplary curbside recycling and waste program 140 is provided in United States Patent Application Publication No. 2008/0172298, entitled “Method of Implementing an Incentive-Based Recycling System,” and assigned to RecycleBank LLC, the disclosure of which is incorporated herein by reference in its entirety.

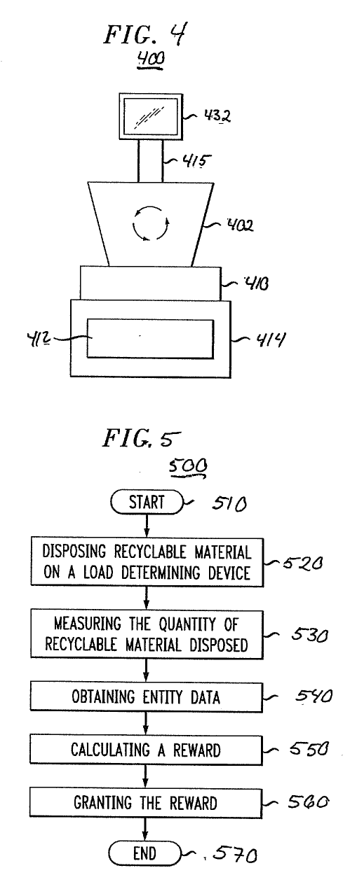

An exemplary kiosk-based recycling and waste program 150 has been developed, and is commercially available through RecycleBank LLC and its affiliates. FIG. 4 depicts an exemplary kiosk apparatus in accordance with one embodiment of the present invention.

The kiosk 400 generally includes a base portion 414, a stand portion 415, a load determining device 410, a data acquisition device 412 and a graphical interface 432. Optionally, a container 402 may be included with the kiosk 400.

The load determining device 410 may include any of, any multiple of, any combination of or any combination of multiples of a scale, load cell, load-cell system, a counting device and/or system or other measuring apparatus or system for (i) determining a quantifiable measure (e.g., weight, quantity, etc.) of the recyclable or waste material and/or (ii) transferring the measurement of materials to the data-acquisition unit 412 for storage and/or subsequent processing.

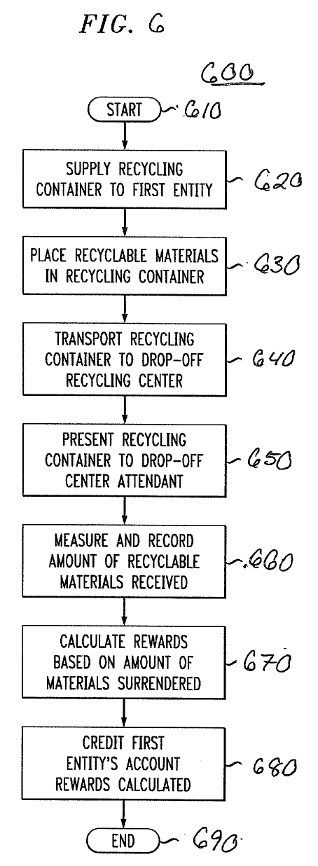

FIG. 5 depicts a general flow chart of an exemplary method utilizing a kiosk-based recycling and waste program 150 in accordance with one embodiment of the present invention. For convenience, the flow diagram 500 is described with reference to the kiosk 400 of FIG. 4. It should be appreciated however, the method 500 may be carried out using other architectures as well.

The method 500 starts at step 510. At step 520, a quantity of recyclable or waste material is deposited by at least one entity. The entity may deposit the quantity of materials to a location that is at least proximate to the kiosk 400. In one embodiment of the present invention, the quantity of recyclable material is deposited on a load determining device 410. The deposited material may be contained within a container 402 for convenience. The deposited material within the container 402 may include a homogeneous composition of recyclable materials, such as only metals, only plastics, or only papers, etc. Alternatively, the deposited material within the container 402 may include a mixed composition of materials. Additionally, the deposited material may also include waste materials, such as residue left within a recyclable container or labeling materials, such as paper or plastic wrappers.

At step 530, the deposited material is measured with the load determining device 410. In one embodiment, the load determining device 410 may determine the deposited material as a function of a plurality of weight measurements of the container 402 obtained before and after the deposited material is transferred to a storage container of the kiosk 400. Alternatively, the load determining device 410 may, for example, determine the quantity of material disposed as a function of a plurality of measurements of quantities of the material in the container 402 obtained before and after such material is transferred to the kiosk 400. Although, generally, the load determining device 410 may measure the weight of a quantity of recyclable materials, the load determining device 410 may determine a measurement in other ways as well, such as by volume, mass, quantity, and the like.

At step 540, user or entity data is obtained. In one embodiment, the entity data obtained may be associated with at least one entity, such as one user of the kiosk 400, one account associated with the kiosk 400, or the like. Alternative embodiments may include obtaining entity data from a plurality of entities, such as, for example, an organization with a plurality of employees, an apartment building with a plurality of tenants, and the like.

Entity data may be obtained through a number of ways. In one embodiment, entity data is obtained by a data acquisition unit 412, adapted to identify an entity. For example, the recycling container 402 may include a specific RFID tag, barcode, or the like, read by the data acquisition unit 412. Entity data may also be obtained by receiving information directly, or substantially directly, from an entity. For example, a data acquisition unit 412 on the kiosk 400 may include a keypad or input device in which an entity may enter a number or code that corresponds to the identity of the entity. The number or code may include a phone number, a personal identification number (PIN) or other number or sequence of characters specific to the entity's identity. The data acquisition unit 412 may also include a reader, in which an entity is identified when a credit card, FOB tag, or other article having the entity's identity, is obtained by the reader.

At step 550 a credit value is calculated, and at step 560 the credit value is granted to the entity's account. Similar to step 380 above, steps 550 and 560 are quite common among all environmentally-conscious systems and programs suitable for embodiments of the present invention, and a further discussion of the generation and allocation of rewards to a user or entity is provided below. The method 500 ends at step 570. A more detailed discussion of an exemplary kiosk-based recycling and waste program 150 is provided in United States Patent Application Publication No. 2008/0296374, entitled “Recycling Kiosk System and Method Thereof,” and assigned to RecycleBank LLC, the disclosure of which is incorporated herein by reference in its entirety.

An exemplary drop-off center recycling and waste program 160 has been developed by RecycleBank LLC. FIG. 6 depicts a general flow chart of an exemplary method utilizing a drop-off center recycling and waste program 160 in accordance with one embodiment of the present invention.

The method 600 begins at step 610. At step 620, the user or entity is supplied a container if or when he or she registers for a recycling or waste management service. In one embodiment of the present invention, the container is identifiable with one particular entity via an identification tag. The entity may be issued a unique identifier which may be embedded within a bar code, RFID tag, or the like, presented either on the container itself, or on a card or key fob provided to the entity. This unique identifier may contain a unique identification number corresponding to the entity.

At step 630, the entity places recyclable or waste materials in the container. The material may be one type of or any combination of types of recyclable material, including, for example, cardboard, paper, plastic, glass and/or aluminum material. Alternatively, the materials may include a combination of any number of waste materials.

At step 640, the entity transports the container to the drop-off center. For example, the entity may transport the container to the center via a car, truck, SUV, or the like.

At step 650, the entity presents the container with recyclable and/or waste materials therein to a drop-off center attendant. During this step, the attendant scans the identification tag on the container with a deciphering device in the attendant's possession. Once the identification tag is scanned, the information received may be optionally verified against the entity data in the database (e.g., the database 125 at the administrator 120) corresponding to the entity.

At step 660, the quantity of materials received is measured and recorded by the load-determining device. Examples of quantifiable measure include, but are not limited to, the weight of the amount of materials, the volume of the materials obtained by estimation or approximation using visual indication (i.e., half-full, quarter-full, etc.), or the like. The load-determining device then transfers this measurable data to the data-acquisition unit for storing and processing of future transactions. The data-acquisition unit may upload this information to the host server. The quantifiable measurement data may also be recorded by the attendant physically, electronically, or the like.

At step 670, a credit value is calculated, correlating to the measure of materials received from the entity. At step 680, the credit value may be allocated to the entity's account. A more detailed description of the credit value calculation and allocating to an entity's account is provided below. At step 690, the method 600 ends. A more detailed discussion of an exemplary drop-off center recycling and waste program 160 is provided in United States Patent Application Publication No. 2009/0014363, entitled “Drop-Off Recycling System and Method Thereof,” and assigned to RecycleBank LLC, the disclosure of which is incorporated herein by reference in its entirety.

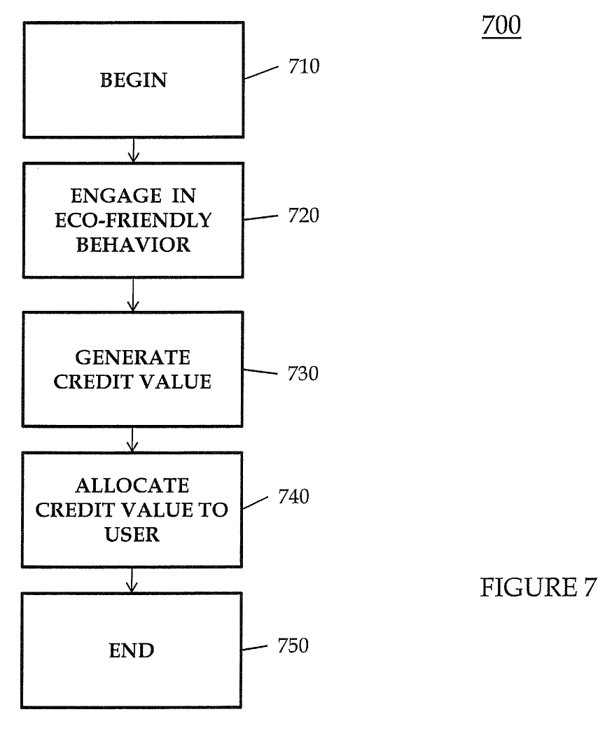

A multitude of exemplary commerce-based environmentally-conscious programs 170 have been developed by RecycleBank LLC. FIG. 7 depicts a general flow chart of merely one exemplary method utilizing a commerce-based environmentally conscious program 170 in accordance with one embodiment of the present invention.

The method 700 begins at step 710. At step 720, a user or entity engages in eco-friendly or environmentally-conscious behavior in a commercial setting (e.g., at a place of business, involving the acquisition or sale of goods or services, or the like). As appreciated by embodiments of the present invention, eco-friendly or environmentally-conscious behavior comprises any action taken by a consumer, which because of such action, yields an environmentally beneficial result when compared to traditional consumer behavior. For example, in one embodiment, environmentally-conscious behavior comprises utilizing a cloth grocery bag rather than receiving plastic bags from the store. In another exemplary embodiment, environmentally-conscious behavior comprises renting a product, rather than purchasing it, thus minimizing waste from manufacturing and yielding less resource consumption. In yet another exemplary embodiment, environmentally-conscious behavior comprises any of the possible multitude of activities throughout the life cycle of a product (e.g., from initial purchase of an energy-efficient product, to the donation of the product to a subsequent consumer, to the recycling of the parts of the product when they are no longer viable, and to the refurbishing of the product with other recycled replacement parts.)

At step 730, a credit value is calculated and/or associated with particular environmentally-conscious behavior, and at step 740, the credit value is designated to the user or entity participating in such environmentally-conscious behavior, and is allocated to the entity's account. A more detailed description of the credit value calculation and allocation to an entity's account is provided below. At step 750, the method 700 ends.

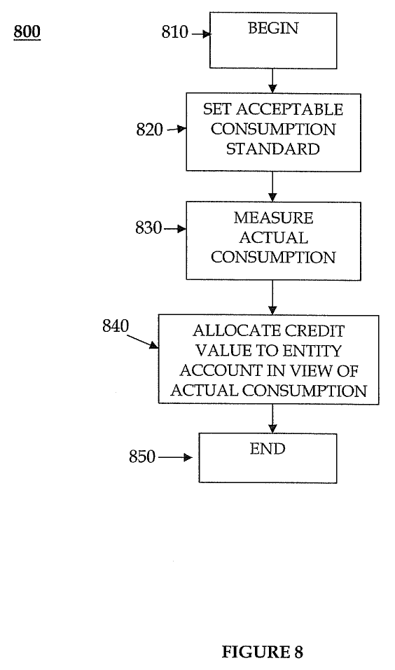

A multitude of exemplary utility- and commodity-based conservation programs 180 have been developed by RecycleBank LLC. FIG. 8 depicts a general flow chart of merely one exemplary method utilizing a utility- and commodity-based conservation program 180 in accordance with one embodiment of the present invention.

The method 800 begins at step 810. At step 820, an acceptable utility or commodity consumption standard is provided for the entity. In one embodiment of the present invention, the acceptable consumption standard is set by the supplier of such utility or commodity. For example, involving a water conversation model, a municipal water facility may monitor monthly or quarterly household consumption of water in a certain geographical area. The municipal water facility may estimate, using its expert knowledge in the industry, that a typical household using a reasonable effort to cut back on water usage should only consume about XXX hundred cubic feet (HCFs) of water per quarter. As such, the acceptable consumption standard may be provided as XXX HCFs per quarter, or (⅓)XXX HCFs per month.

In another embodiment, the acceptable consumption standard may provided as entity-specific, that is, each entity's usage is compared against its usage from a similar previous time period or compared against its usage from a previous time period and adjusted for temperature and moisture level changes and other factors that affect resource use differences. For example, if an entity utilized YYY kWh of energy during the month of July in year one, the acceptable consumption standard for the entity in July in year two may be 90% of YYY kWh. In a similar example, if the entity utilizes about ZZZ CFs of water during the first quarter of the year (i.e., January-March), the acceptable consumption standard may be 95% of ZZZ CFs for the second quarter of the year (i.e., April-June).

At step 830, the actual resource consumption of the entity is measured. In one embodiment, a measuring device obtains a measurement of the specific resource consumption, generally over a particular time interval. Often the measuring device also comprises a reporting means. In one embodiment, the reporting means connects with the administrator, through the network, and updates the specific records in a database with necessary data for the entity. In another embodiment, the reporting means requires a manual intervention (e.g., a telephone call-in program to the host, a data entry portal available through the Internet, and the like). In such an embodiment, the entity may be required to obtain a measurement of resource consumption (often provided as a cumulative numerical value of consumption over a significant period of time—from which a particular measurement can be obtained by comparing to a previous measurement and taking a tare value). The entity may then have to type, message, discuss, or otherwise relay such measurement to the administrator.

At step 840, the actual resource consumption is compared to the acceptable consumption standard, and if the entity conserved sufficient resources, a reward/credit may be allocated to the entity's account stored with the administrator. A more specific description of the calculating and allocating of rewards is provided below. The method 800 ends at step 850. A more detailed discussion of an exemplary utility- and commodity-based conservation program 180 is provided in U.S. Provisional Patent Application No. 61/146,521, entitled “System and Method for Incentive-Based Resource Conservation,” and assigned to RecycleBank LLC, the disclosure of which is incorporated herein by reference in its entirety.

Referring back to FIG. 1, each of the sub-systems within the system 100 are in communication with the administrator 120 through the network 110. In many embodiments, the sub-systems are also in communication with the user 130 via the network 110. As understood by embodiments of the present invention, communication with the administrator 120 generally comprises, at a minimum, the reporting of a measurement associated with an entity, as discussed above, for purposes of credit value calculation and allocation, as discussed below.

Often, the administrator 120 provides an accessible website, data portal, or forum to allow the user 130, the managing entities of the various sub-systems, and vendors (not shown) within the system 100 to engage the administrator or one another in accordance with embodiments of the present invention. Most frequently, embodiments of the present invention require the ability for an entity to manage accumulated credit value units associated with the entity's account, as discussed below, through such an administrator-hosted forum. In one commercially available embodiment, such type of interactive forum is available through web-accessible software, managed under the trademark ECOSTRONG, developed and administered by RecycleBank LLC.

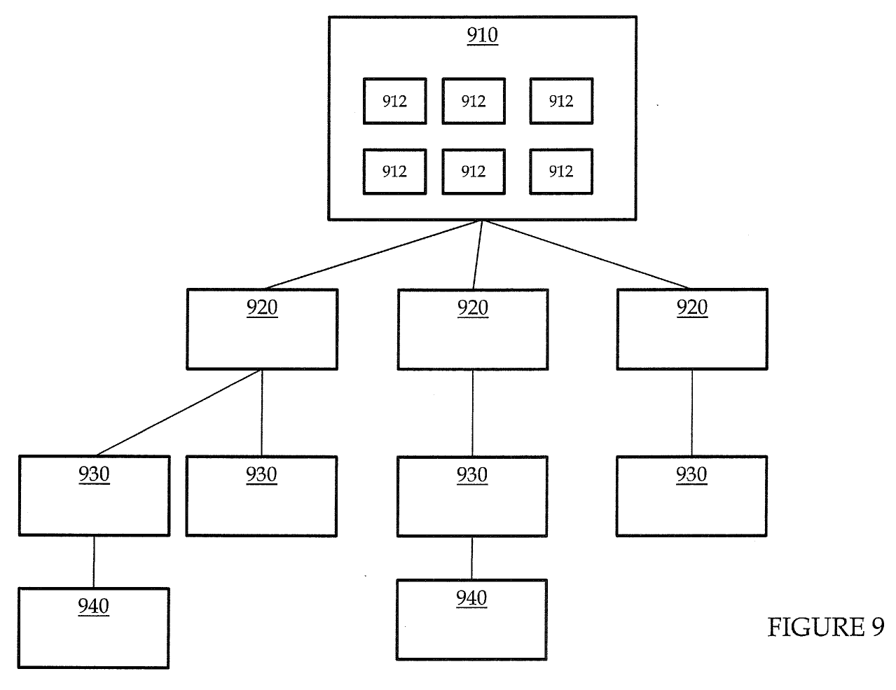

FIG. 9 depicts a graphical representation of a point-source asset system in accordance with one embodiment of the present invention. The point-source asset system 900 is a data system showing organization of various assets and subscriptions within a user or entity's account, as stored on a database (e.g., the database 125).

Generally, a user 130 of the general system 100, acquires an account (“entity's account” 910) from the administrator 120, as a construct for storing units. As used herein, the term “unit” may refer to a unit which serves as a unit of account, a medium of exchange, and a store of value. Units may include, but are not limited to, units of credit value, currency, tokens, reward points, or any other units suitable for embodiments of the present invention.

In many embodiments, information pertaining to an entity's account 910 includes personal information of the participant or participants (name, address, telephone number, and the like), amount of units available, amount of units spent, total amount of units obtained, any other account information feasible in the context of the present invention, or combinations thereof. Such information is generally available as data points 912 or subsets of data, as represented in the FIG. 9.

An entity's account is able to obtain units through at least one subscription 920 to at least one point source asset 930. In accordance with embodiments of the present invention, a subscription 920 may include an entity's participation in any of the sub-systems as disclosed herein. For example, if an entity 130 participated in a curbside recycling and waste program 140 and a utility- and commodity-based conservation program 180, each sub-system would constitute a subscription 920.

As used herein, a “point source asset” 930 may refer to any asset that allows an entity's account 910 to earn units within a subscription 920. In accordance with embodiments of the present invention, exemplary point source assets include: patronizing select venues and businesses, participating in selected services or programs, or in certain instances, utilizing a particular apparatus within a selected service or program.

In one embodiment, an entity's point source asset 930 comprises a curbside location (e.g., address) for use with a curbside recycling and waste program 140. In another embodiment, an entity's point source asset 930 may comprise a key card or FOB for use with a kiosk-based recycling and waste program 150 or a drop-off center recycling and waste program 160. In yet another embodiment, an entity's point source asset 930 comprises a unique shopping account number (e.g., an online shopping account accessible only to persons enrolled in an environmentally beneficial program), for use with a commerce-based environmentally-conscious program 170. In one other exemplary embodiment, an entity's point source asset 930 may comprise an water utility account number, as stored with the utility provider, for use with a utility- and commodity-based conservation program 180. As understood by various embodiments of the present invention, any identifiable account or asset, which has a causal relationship with a subscription 920, may be suitable as a point source asset 930.

Optionally, the point source asset system 900 may track point source asset data 940, for each point source asset 930. For example, where a point source asset 930 comprises a curbside location, the point source asset data 940 may comprise the unique identifier number on the curbside container (if different than the entity's account number), the date of issuance of the curbside container, and where applicable, end dates for the particular curbside container (e.g., if the curbside container became cracked or unusable, it may be replaced with a new curbside container.)

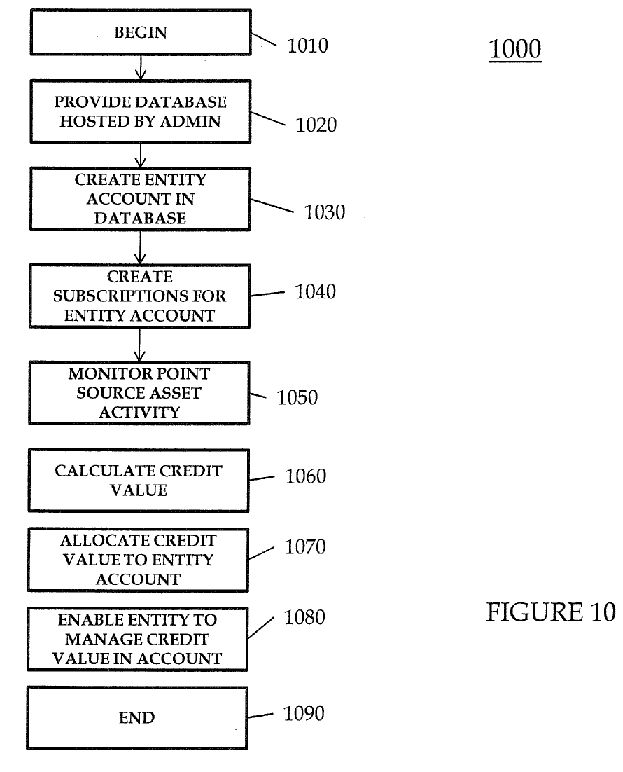

FIG. 10 depicts a flowchart of a method of managing an incentive-based environmentally-conscious behavior program using a point-source asset system, in accordance with one exemplary embodiment of the present invention. For convenience, the method 1000 is described with reference to the general system 100 of FIG. 1, and the point-source asset system 900 of FIG. 9. It should be appreciated however, the method 1000 may be carried out using other architectures and environments as well.

The method 1000 begins at step 1010. At step 1020, a database 125 hosted by a server at an administrator 120 is provided in communication with at least an entity 130, and at least a sub-system (e.g., 140-180), via a network 110.

At step 1030, the entity's account 910 is created within the database 125 for the entity 130. At step 1040, for each sub-system within the system 100, a subscription 920 is created within the entity's account 910. Generally, when the subscription 920 is created, at least one point-source asset 930 associated with the subscription 920 is also designated within the entity's account 910.

At step 1050, as the entity 130 participates in the sub-system or program, activity associated with each point-source asset 930 is monitored by the administrator 120. Depending on the type of sub-system, the activity associated with each point-source asset 930 may greatly vary. In one example, where a commerce-based environmentally-conscious program 170 is engaged, mere participation by the entity 130 may be monitored activity. In another example, for a curbside recycling and waste program 140, the amount of recyclables or waste put in the container at a particular pick-up may be the monitored activity.

At step 1060, a credit value, or units of credit value, may be calculated, correlating to the monitored activity associated with each point source asset 930. The credit value may be derived from an algorithm which takes as an input, for example, a quantization or qualification of the activity associated with the particular point source asset 930. Alternative algorithms may account for at least one of a value of products or services obtained from a participating business, an amount of money spent on goods or services at a participating business, an amount of recyclable material recycled in a recycling program, the comparative decrease in waste between consecutive participation periods, or any other source of measurable data suitable for embodiments of the present invention.

The following non-limiting examples may be suitable algorithmic basis for credit value determination with the respective point-source assets 930.

For a curbside address or location, a suitable algorithm may utilize mere participation, quantitative measurement values (e.g., weight, volume, mass, density) of recyclable or waste materials within a container, relative qualitative measurement values in consecutive periodic intervals (e.g., week 2 materials compared to week 1 materials), or the like.

For a key card or FOB tag, used with a kiosk-based recycling and waste program 150 or a drop-off center recycling and waste program 160, a suitable algorithm may be very similar to those above with a curbside address or location. In addition, suitable algorithms may also account for communal participation (e.g., comparative measurements among residents in an apartment building or percentages of overall production).

For a unique shopping account number, suitable algorithms may be based upon the amount of purchase, the value of a donation, or the like. Similarly, suitable algorithms may include preferred treatment or exclusivity for select vendors (e.g., only certain retail stores will allow units to accumulate).

For a utility account number, suitable algorithms may likely be based upon the actual usage of a utility compared to an acceptable limit. Similarly, suitable algorithms may account for consecutive or comparative periodic measurements (e.g., compare the electric bill from July, Year 2 to July, Year 1).

As an alternative to mathematical algorithms, credit values may also be calculated in a fixed amount. For example, a fixed amount of units in response to a single purchase from a participating vendor or business. Or similarly, a fixed amount of units for mere participation in a program. The fixed amount may be activated by a purchase, a patronization, a service, a delivery, or any other activation activity suitable for embodiments of the present invention.

At step 1070, the calculated credit value, correlating to the point-source asset activity, is allocated to the entity's account 910. The credit value may be stored with the entity's account 910 in the database 125 as a data point 912. In many embodiments, the calculated credit value is added to a cumulative tally of units stored with the entity's account 910, reflective of the entity's cumulative participation in the system 100.

At step 1080, the entity 130 is permitted to manage the credit value units associated with the entity account 910. In accordance with one embodiment of the present invention, credit value units may be exchanged for rewards. As used herein, the term “rewards” may refer to any service, good, discount, price reduction, monetary grant, or other incentive, financial or otherwise, which is obtained as a result of an exchange of units. Rewards may include, but are not limited to, gift certificates, coupons, price-reduced or free goods and/or services, or any other reward suitable within the scope of embodiments of the present invention.

Generally, included in the management of the entity's account 910, is the entity's ability to engage in certain reward-based transactions, including, but not limited to: vendor redemption, auctions, sweepstakes, donations, transfers, and purchases (i.e., self-purchase or gift purchase).

In one embodiment, the entity 130 is able to redeem the rewards associated with the entity account at a participating vendor. Each vendor may have a different value associated with a reward, and as such, each vendor may allow entities to redeem rewards in various ways. For example, some vendors may provide a reward to dollar association (e.g., 10 rewards equals up to 1 dollar value with the vendor), other vendors may provide a product to reward value (e.g., in exchange for 10 reward units, the entity receives one free widget), other vendors may provide an additional purchase value to the reward value (e.g., in exchange for 10 reward units, the entity may buy one get one free), and other vendors may provide a discount to reward value (e.g., 10% off entire purchase in exchange for 10 rewards). Other similar value scenarios may exist as well.

The vendor may provide a shopping forum either through an online store via a computer network or in a traditional retail store. If the entity 130 wishes to redeem rewards with the vendor through an online store, access may generally be provided through a redemption link on the entity's account 910, when accessed by the entity 130 at the administrator 120. In some embodiments, however, it may be necessary for the entity 130 to go to a website hosted by the vendor, and utilizing a virtual certificate, coupon, or similar identification code, and enter such code before redemption of rewards is allowed. In a traditional retail store environment, it is generally necessary for the user to print a physical coupon or certificate, having an identification code, and bring the coupon or certificate with the entity at the time of purchase/redemption.

In another embodiment, an entity 130 may be able to participate in an auction, a sweepstakes, donate rewards to a charitable organization (e.g., educational facility, non-profit group, or the like) or transfer rewards to another entity's account. In an additional embodiment, an entity 130 may also purchase additional rewards for the entity's own account or for another entity's account, using a credit card or other traditional payment means.

In accordance with yet another embodiment of the present invention, an entity 130 may have access to resource consumption data at any desired time. Accessible data may comprise the entity's own resource consumption data, the resource consumption data of others, statistical derivations of any set of resource consumption data (e.g., average, median, mode, variance, standard deviation), or the like. This data and information may be available to the entity 130 through the network 110, either on the entity's account 910, a general informational webpage hosted by the administrator 120, or the like.

In another embodiment of the present invention, an entity 130 may be required to purchase a subscription to participate in one or more embodiments of the invention as described herein by paying a one-time or periodic subscription fee. The payment of such a fee may allow and entity to participate and, consequently, to obtain and/or redeem rewards. The method 1000 ends at step 1090.

While the foregoing is directed to embodiments of the present invention, other and further embodiments of the invention may be devised without departing from the basic scope thereof.

What is claimed is:

1. A system comprising:
an administrative entity, communicably accessible via a computer network, comprising a database;
a consumer entity having an entity account stored on the database;
an environmentally-conscious sub-program, comprising a point-source asset, associated with the entity account;
a means for monitoring point-source asset activity within the environmentally-conscious sub-program; and
a means for granting a credit value, correlating to the point-source asset activity, to the entity account.

2. The system of claim 1, further comprising a means for enabling the consumer entity to manage the credit values associated with the entity account.

3. The system of claim 2, wherein the means for enabling the consumer entity to manage the credit values comprises enabling the consumer entity to redeem the credit values for a reward with a third party vendor.

4. The system of claim 1, wherein the environmentally-conscious sub-program comprises one of a curbside recycling and waste program, kiosk-based recycling and waste program, drop-off center recycling and waste program, commerce-based environmentally-conscious program, or utility- and commodity-based conservation program.

5. The system of claim 1, wherein a plurality of environmentally-conscious sub-programs, each comprising a point-source asset, are associated with the entity account.

6. The system of claim 5, wherein each of the plurality of environmentally-conscious sub-programs comprise a plurality of point source assets associated with the entity account.

7. A method of managing a system, comprising:
providing a database hosted on a server at an administrative entity;
creating an entity account within the database for a consumer entity;
associating an environmentally-conscious sub-program, comprising a point-source asset, with the entity account;
monitoring point-source asset activity within the environmentally-conscious sub-program; and
granting a credit value, correlating to the point-source asset activity, to the entity account.

8. The method of claim 7, further comprising enabling the consumer entity to manage the credit values associated with the entity account.

9. The method of claim 8, wherein enabling the consumer entity to manage the credit values comprises enabling the consumer entity to redeem the credit values for a reward with a third party vendor.

10. The method of claim 9, wherein redeeming the credit values for a reward with a third party vendor is conducted through a network-based shopping forum.

11. The method of claim 7, wherein the environmentally-conscious sub-program comprises one of a curbside recycling and waste program, kiosk-based recycling and waste program, drop-off center recycling and waste program, commerce-based environmentally-conscious program, or utility- and commodity-based conservation program.

12. The method of claim 7, wherein a plurality of environmentally-conscious sub-programs, each comprising a point-source asset, are associated with the entity account.

13. The method of claim 12, wherein each of the plurality of environmentally-conscious sub-programs comprise a plurality of point source assets associated with the entity account.

14. A tangible computer readable medium comprising program instructions, wherein the program instructions are computer-executable to implement:
creating an entity account within the database for a consumer entity;
associating an environmentally-conscious sub-program, comprising a point-source asset, with the entity account;
monitoring point-source asset activity within the environmentally-conscious sub-program; and
granting a credit value, correlating to the point-source asset activity, to the entity account.

15. The tangible computer readable medium of claim 14, further comprising enabling the consumer entity to manage the credit values associated with the entity account.

16. The tangible computer readable medium of claim 15, wherein enabling the consumer entity to manage the credit values comprises enabling the consumer entity to redeem the credit values for a reward with a third party vendor.

17. The tangible computer readable medium of claim 14, wherein the environmentally-conscious sub-program comprises one of a curbside recycling and waste program, kiosk-based recycling and waste program, drop-off center recycling and waste program, commerce-based environmentally-conscious program, or utility- and commodity-based conservation program.

18. The tangible computer readable medium of claim 14, wherein a plurality of environmentally-conscious sub-programs, each comprising a point-source asset, are associated with the entity account.

19. The tangible computer readable medium of claim 19, wherein each of the plurality of environmentally-conscious sub-programs comprise a plurality of point source assets associated with the entity account.

20. The tangible computer readable medium of claim 14, wherein the tangible computer readable medium is stored on a server, hosted by an administrative entity.
